(19) United States
(12) Patent Application Publication
(10) Pub. No.: US 2007/0067996 A1
(43) Pub. Date: Mar. 29, 2007

(54) Multifunctional wire stripper

(76) Inventor: Ming Chi Chang, Taichung County (TW)

Correspondence Address: CHARLES E. BAXLEY, ESQ., 90 JOHN STREET, THIRD FLOOR, NEW YORK, NY, 10038, US

(21) Appl. No.: 11/234,934

(22) Filed: Sep. 26, 2005

(51) Int. Cl. B26B 27/00

(52) U.S. Cl. 30/90.1

(57) ABSTRACT

A wire stripper includes a first blade seat, a second blade seat movable relative to the first blade seat, a first stripping blade mounted on an inner face of the first blade seat, a second stripping blade mounted on an inner face of the second blade seat and pivotally connected with the first stripping blade, a first cutting blade mounted on the inner face of the second blade seat, and a second cutting blade mounted on the inner face of the second blade seat. Thus, the wire stripper can be used to cut, strip and press a wire, so that the wire stripper has multiple functions, thereby facilitating a user operating the wire stripper.

### BACKGROUND OF THE INVENTION

1. Field of the Invention

The present invention relates to a wire stripper, and more particularly to a multifunctional wire stripper.

2. Description of the Related Art

A conventional wire stripper comprises two handles pivotally connected with each other and each having a plurality of stripping grooves. Thus, the stripping grooves of the two handles are clamped on a wire to strip the outer insulating layer of a wire. However, the conventional wire stripper can be used to strip the outer insulating layer of wires having a smaller diameter and cannot be used to strip the outer insulating layer of wires having a larger diameter, thereby decreasing the versatility of the wire stripper.

The closest prior art references of which the applicant is aware are disclosed in the Taiwanese Patent Publication No. 499089, 572465, 576575 and 584332.

### SUMMARY OF THE INVENTION

The present invention is to mitigate and/or obviate the disadvantage of the conventional wire stripper.

The primary objective of the present invention is to provide a wire stripper having multiple wire stripping functions.

Another objective of the present invention is to provide a wire stripper that can be used to cut, strip and press a wire, so that the wire stripper has multiple functions, thereby facilitating a user operating the wire stripper.

A further objective of the present invention is to provide a wire stripper that can be used to directly strip the outer insulating layer of wires having a smaller diameter and a larger diameter and can also be used to combine a terminal with a wire, thereby enhancing the versatility of the wire stripper.

In accordance with the present invention, there is provided a wire stripper, comprising:

a first blade seat;

a second blade seat movable relative to the first blade seat;

a first stripping blade mounted on an inner face of the first blade seat;

a second stripping blade mounted on an inner face of the second blade seat and pivotally connected with the first stripping blade by a pivot shaft;

a first cutting blade mounted on the inner face of the second blade seat;

a second cutting blade mounted on the inner face of the second blade seat.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wire stripper in accordance with the preferred embodiment of the present invention;

FIG. 2 is an exploded perspective view of the wire stripper as shown in FIG. 1;

FIG. 3 is a schematic operational view of the wire stripper as shown in FIG. 1;

FIGS. 4A and 4B are perspective views showing operation of the wire stripper as shown in FIG. 1;

FIGS. 5A and 5B are perspective views showing operation of the wire stripper as shown in FIG. 1;

FIG. 6 is a schematic operational view of the wire stripper as shown in FIG. 5A;

FIGS. 7A and 7B are perspective views showing operation of the wire stripper as shown in FIG. 1; and

FIGS. 8A and 8B are perspective views showing operation of the wire stripper as shown in FIG. 1.

### DETAILED DESCRIPTION OF THE INVENTION

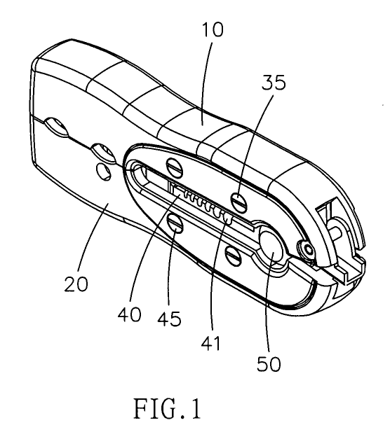

Referring to the drawings and initially to FIGS. 1-3, a wire stripper in accordance with the preferred embodiment of the present invention comprises a first blade seat 10, a second blade seat 20 movable relative to the first blade seat 10, a first stripping blade 30 mounted on an inner face of the first blade seat 10, a second stripping blade 40 mounted on an inner face of the second blade seat 20 and pivotally connected with the first stripping blade 30 by a pivot shaft 50, a torsion spring 55 mounted on the pivot shaft 50 and biased between the first stripping blade 30 and the second stripping blade 40 to push the first stripping blade 30 and the second stripping blade 40 outward relative to each other, a first cutting blade 60 mounted on the inner face of the second blade seat 20, and a second cutting blade 70 mounted on the inner face of the second blade seat 20.

The first blade seat 10 has a free end formed with a plurality of first stripping teeth 15. The first blade seat 10 has an end portion located corresponding to the pivot ends of the first stripping blade 30 and the second stripping blade 40 and formed with a pivot recess 11.

A stop block 13 is pivotally mounted in the pivot recess 11 of the first blade seat 10 by a pivot axle 12. The stop block 13 is substantially L-shaped and has two ends each formed with a first resting face 130 rested on an end face of the first blade seat 10 and a second resting face 131 rested on an end face of the second blade seat 20. The end face of the second blade seat 20 has a side formed with an abutment 21 rested on the second resting face 131 of the stop block 13.

The second blade seat 20 has a free end formed with a plurality of second stripping teeth 25 aligning with the first stripping teeth 15 of the first blade seat 10.

The first stripping blade 30 is locked on the inner face of the first blade seat 10 by locking screws 35. The first stripping blade 30 has a mediate portion formed with a retaining slot 33 for retaining a first end of the torsion spring 55. The first stripping blade 30 has a face formed with a plurality of substantially semi-cylindrical first stripping grooves 31 having different sizes. The first stripping blade 30 has a free end formed with a serrated first press portion 32.

The second stripping blade 40 is locked on the inner face of the second blade seat 20 by locking screws 45. The second stripping blade 40 has a mediate portion formed with a second retaining slot 43 for retaining a second end of the torsion spring 55. The second stripping blade 40 has a face formed with a plurality of substantially semi-cylindrical a second stripping grooves 41 having different sizes and aligning with the first stripping grooves 31 of the first stripping blade 30. The second stripping blade 40 has a free end formed with a serrated second press portion 42 aligning with the first press portion 32 of the first stripping blade 30.

The first cutting blade 60 is locked on the inner face of the first blade seat 10 by a locking screw 65. The first cutting blade 60 is extended in an axial direction of the second blade seat 20 and located in front of the second stripping blade 40.

The second cutting blade 70 is locked on the inner face of the first blade seat 10 by a locking screw 75. The second cutting blade 70 is extended in a transverse direction of the second blade seat 20 and located in front of the first cutting blade 60. The second cutting blade 70 is perpendicular to the first cutting blade 60.

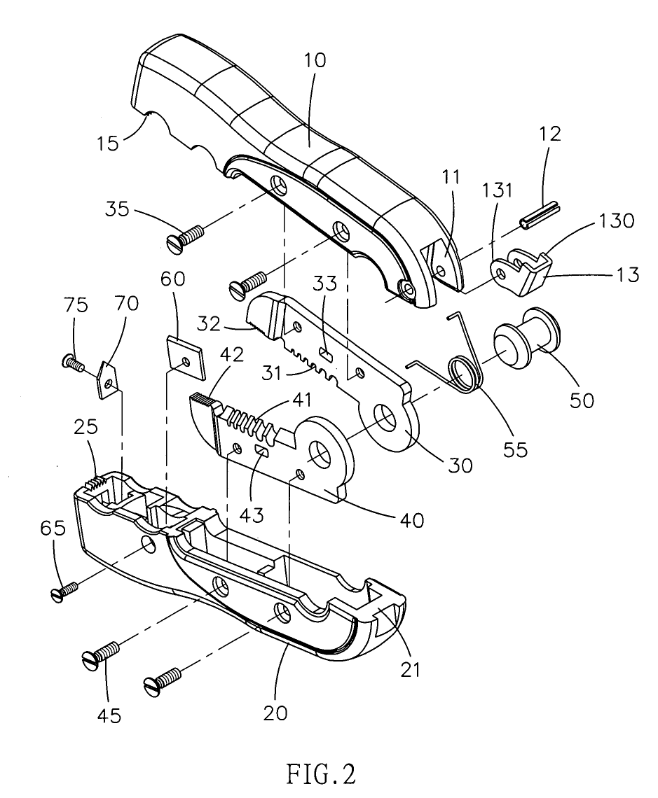

As shown in FIGS. 1 and 2, when the first stripping blade 30 and the second stripping blade 40 are closed, the stop block 13 is pushed upward so that the first resting face 130 of the stop block 13 is rested on the end face of the first blade seat 10 and the second resting face 131 of the stop block 13 is rested on the end face of the second blade seat 20 to lock the first blade seat 10 and the second blade seat 20 to prevent the first blade seat 10 and the second blade seat 20 from being expanded outward, thereby facilitating a user folding and storing the wire stripper.

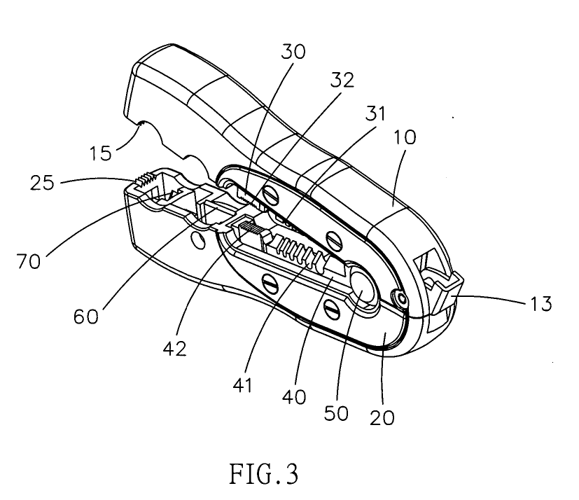

As shown in FIGS. 2 and 3, when the stop block 13 is pulled downward, the first resting face 130 of the stop block 13 is detached from the end face of the first blade seat 10 and the second resting face 131 of the stop block 13 is detached from the end face of the second blade seat 20 to unlock the first blade seat 10 and the second blade seat 20 so that the first blade seat 10 and the second blade seat 20 are expanded outward by the restoring force of the torsion spring 55 for use with the user.

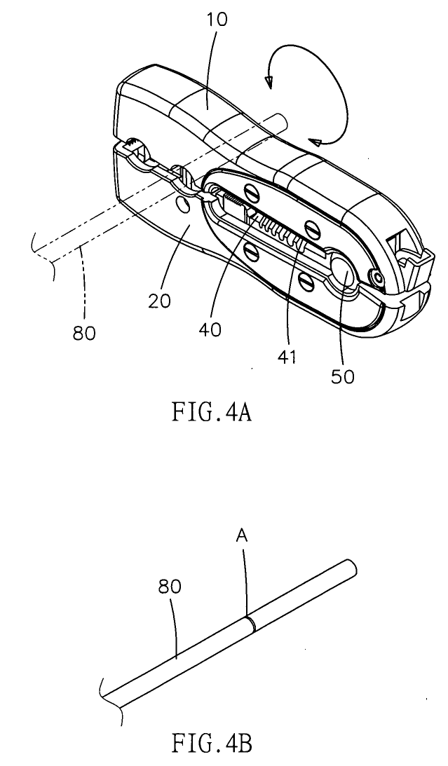

As shown in FIGS. 4A and 4B, a wire 80 having a larger diameter is placed onto the first cutting blade 60. Then, the first blade seat 10 and the second blade seat 20 are pressed toward each other to close the wire 80 in the wire stripper. Then, the wire stripper is rotated relative to the wire 80, so that the periphery of the wire 80 is formed with an annular transverse slit “A” by the first cutting blade 60.

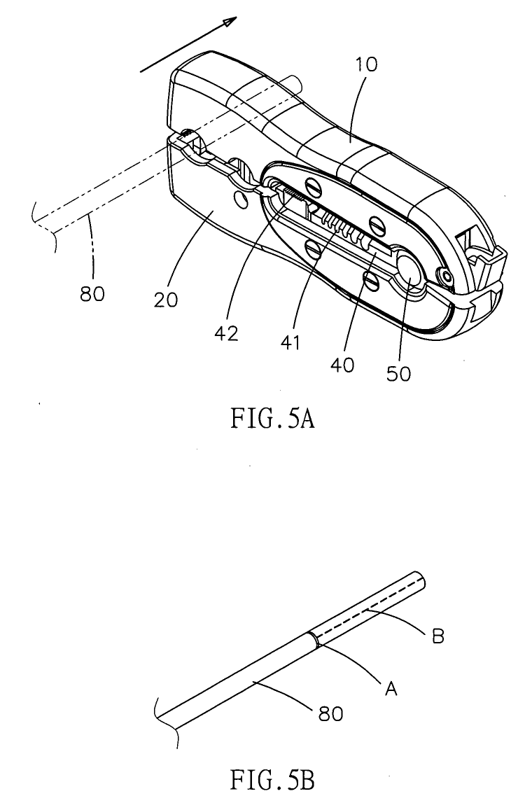

As shown in FIGS. 5A and 5B, the wire 80 is placed onto the second cutting blade 70. Then, the wire 80 is pulled outward relative to the wire stripper, so that a longitudinal slit “B” is formed in the periphery of the wire 80 by the first cutting blade 60 and located between the transverse slit “A” and the free end of the wire 80.

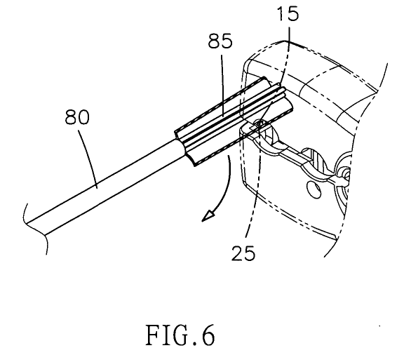

As shown in FIG. 6, the outer insulating layer of the wire 80 is stripped by the first stripping teeth 15 of the first blade seat 10 and the second stripping teeth 25 of the second blade seat 20, thereby exposing the inner thread 85 having a smaller diameter.

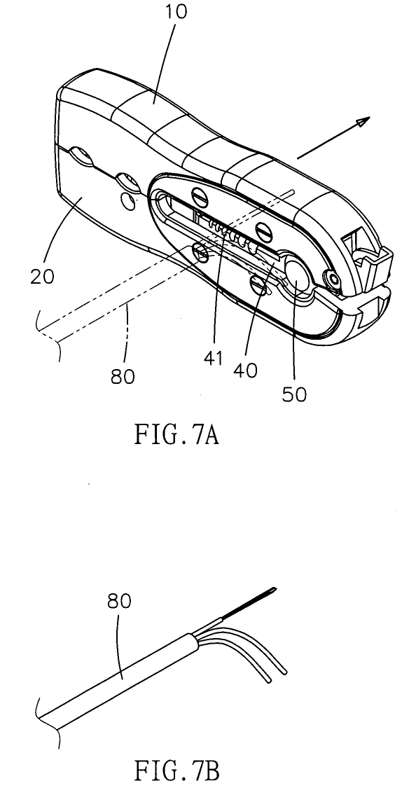

As shown in FIGS. 7A and 7B, the inner thread 85 having a smaller diameter is clamped by the first stripping grooves 31 of the first stripping blade 30 and the second stripping grooves 41 of the second stripping blade 40. Then, the wire stripper is rotated relative to the inner thread 85, and the inner thread 85 is pulled outward relative to the wire stripper, so that the outer insulating layer of the inner thread 85 is stripped.

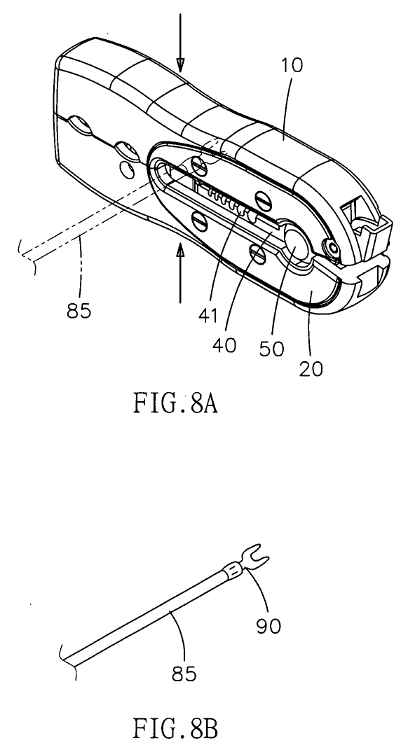

As shown in FIGS. 8A and 8B, a terminal 90 is placed onto the inner thread 85. Then, the terminal 90 and the inner thread 85 are clamped by the first press portion 32 of the first stripping blade 30 and the second press portion 42 of the second stripping blade 40 so that the terminal 90 is combined with the inner thread 85.

Accordingly, the wire stripper can be used to cut, strip and press a wire, so that the wire stripper has multiple functions, thereby facilitating a user operating the wire stripper. In addition, the wire stripper can be used to directly strip the outer insulating layer of wires having a smaller diameter and a larger diameter and can also be used to combine a terminal with a wire, thereby enhancing the versatility of the wire stripper.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wire stripper, comprising:
a first blade seat;
a second blade seat movable relative to the first blade seat;
a first stripping blade mounted on an inner face of the first blade seat;
a second stripping blade mounted on an inner face of the second blade seat and pivotally connected with the first stripping blade by a pivot shaft;
a first cutting blade mounted on the inner face of the second blade seat;
a second cutting blade mounted on the inner face of the second blade seat.

2. The wire stripper in accordance with claim 1, further comprising a torsion spring mounted on the pivot shaft and biased between the first stripping blade and the second stripping blade to push the first stripping blade and the second stripping blade outward relative to each other.

3. The wire stripper in accordance with claim 2, wherein the first stripping blade has a mediate portion formed with a retaining slot for retaining a first end of the torsion spring, and the second stripping blade has a mediate portion formed with a second retaining slot for retaining a second end of the torsion spring.

4. The wire stripper in accordance with claim 1, wherein the first blade seat has a free end formed with a plurality of first stripping teeth, and the second blade seat has a free end formed with a plurality of second stripping teeth aligning with the first stripping teeth of the first blade seat.

5. The wire stripper in accordance with claim 1, wherein the first blade seat has an end portion located corresponding to the pivot ends of the first stripping blade and the second stripping blade and formed with a pivot recess.

6. The wire stripper in accordance with claim 5, wherein the further comprising a stop block pivotally mounted in the pivot recess of the first blade seat by a pivot axle.

7. The wire stripper in accordance with claim 6, wherein the stop block is substantially L-shaped.

8. The wire stripper in accordance with claim 6, wherein the stop block has two ends each formed with a first resting face rested on an end face of the first blade seat and a second resting face rested on an end face of the second blade seat.

9. The wire stripper in accordance with claim 8, wherein the end face of the second blade seat has a side formed with an abutment rested on the second resting face of the stop block.

10. The wire stripper in accordance with claim 1, wherein the first stripping blade is locked on the inner face of the first blade seat by locking screws.

11. The wire stripper in accordance with claim 1, wherein the first stripping blade has a face formed with a plurality of substantially semi-cylindrical first stripping grooves having different sizes, and the second stripping blade has a face formed with a plurality of substantially semi-cylindrical a second stripping grooves having different sizes and aligning with the first stripping grooves of the first stripping blade.

12. The wire stripper in accordance with claim 1, wherein the first stripping blade has a free end formed with a serrated first press portion, and the second stripping blade has a free end formed with a serrated second press portion aligning with the first press portion of the first stripping blade.

13. The wire stripper in accordance with claim 1, wherein the second stripping blade is locked on the inner face of the second blade seat by locking screws.

14. The wire stripper in accordance with claim 1, wherein the first cutting blade is locked on the inner face of the first blade seat by a locking screw.

15. The wire stripper in accordance with claim 1, wherein the first cutting blade is extended in an axial direction of the second blade seat and located in front of the second stripping blade.

16. The wire stripper in accordance with claim 1, wherein the second cutting blade is locked on the inner face of the first blade seat by a locking screw.

17. The wire stripper in accordance with claim 1, wherein the second cutting blade is extended in a transverse direction of the second blade seat and located in front of the first cutting blade.

18. The wire stripper in accordance with claim 1, wherein the second cutting blade is perpendicular to the first cutting blade.
